(19) United States
(12) Patent Application Publication
(10) Pub. No.: US 2012/0029900 A1
(43) Pub. Date: Feb. 2, 2012

(54) SIMULATION METHOD AND SYSTEM FOR SIMULATING A MULTI-CORE HARDWARE PLATFORM

(75) Inventor: FRANCESCO PAPARIELLO, San Fermo della Battaglia (IT)

(73) Assignee: STMICROELECTRONICS S.R.L., AGRATE BRIANZA (IT)

(21) Appl. No.: 13/193,112

(22) Filed: Jul. 28, 2011

(30) Foreign Application Priority Data
Jul. 28, 2010 (IT) VI2010A000208

(51) Int. Cl. G06F 17/50

(52) U.S. Cl. 703/21

(57) ABSTRACT

Embodiments of the invention relate to methods and systems for simulating a multi-core hardware platform the devices of which are modeled by functional or cycle-based models. In order to improve the simulation speed, a computer implemented method utilizes functional models that include an execution time in the reply to a transaction while maintaining the simulation accuracy relative to a cycle-based simulation of the same hardware platform. The execution time indicates an estimated number of cycles of a main clock which the represented device would have required for executing the operation. The simulation system initiates a transaction by a master model to request the execution of an operation by a slave model. The slave model executes the requested operation, and replies to the transaction returning a result of the executed operation to the master model, and where the slave model is a functional model, the execution time.

### PRIORITY CLAIM

The present application claims the benefit of Italian Patent Application No. VI2010A000208, filed Jul. 28, 2010, which application is incorporated herein by reference in its entirety.

### TECHNICAL FIELD

Embodiments of the present invention relate to a method for simulating a multi-core hardware platform. Embodiments of the present invention provide a method for simulating a multi-core hardware platform including a plurality of devices, wherein each device can be modeled as functional model or as cycle-based model. Embodiments of the present invention define simulations including functional models or cycle-based models where the functional models are capable of including an execution time in the reply to a transaction.

### BACKGROUND

Multi-core hardware platforms are used in a majority of electronic appliances, for instance, in a private or a professional environment with the need for a large amount of processing power. Appliances for multi-core hardware platforms may be dedicated devices which are operating, e.g., in a standalone multimedia device such as a DVD player, Blu-Ray player or hard-drive video recorder, a TV, a multi-channel HIFI system, a networking device, a mobile phone, a personal digital assistant (PDA) and an MP3 player, or general purpose devices such as computers and the like. Such appliances demand different functionality which may be realized by the hardware-platform connecting plural devices or “IP building blocks” with a special functionality via a bus-like or a point-to-point like data connection. Accordingly, the flow of data and/or instructions between the different devices or IP building blocks is essential to the functioning of the whole appliance. The terms IP and IP building block are each used herein as a synonym for a device.

During the design phase of such an appliance, a simulation platform is used to validate and to verify the functionality and to evaluate the performance of the hardware platform. Further, the simulation can also be used during testing to compare the simulated result with the results produced by an implementation of the hardware platform. There are also other advantageous combinations of a simulation and of a hardware implementation, for instance when the functionality of one device is performed only by the simulation and the other devices, with which the first device communicates, are already hardware implemented prototypes.

A hardware platform combines a plurality of hardware devices or IP building blocks. Thus, in a chip, usually multiple devices or IP building blocks are combined. Nevertheless, devices or IP building blocks may also be realized as separate chips. For instance, in a multi-chip design the communication between chips representing a device or IP building block may be realized via wires on a printed circuit board.

In order to distinguish the roles of a device or IP building block, the transaction model can be used. A transaction refers to an operation to be performed by two devices or IPs. A first device initiates the transaction and, hence, is called a master IP. The second device only responds to the transaction and, hence, is called a slave IP. The response of the slave IP may require some computations to be performed by the slave IP. Master IPs can for example be: CPUs (“central processing unit”), DMAs (“Direct Memory Access”), hardware accelerators and the like. Slave IPs connected to such transaction initiators or master IPs are for example: communication buses, network interfaces, memories, caches and the like. Typically, a master IP is connected to plural slave IPs to form a subsystem. However, a slave IP may also be shared amongst plural master IPs.

Further, there exists the additional case of one device or IP building block having the role of a slave IP regarding one transaction and the role of a master IP for a different transaction. This exception arises when the device or IP building block depends on a different device or IP building block to provide additional information. For example, a cache may depend on a memory whenever the data is not available in the cache itself. However, as the memory access is managed by the cache transparent to the CPU, the cache acts in the role of a slave IP for the CPU and in the role of a master IP for the memory. Thus, the two terms may also be used for the same device or IP building block as in the present example.

For simulating the above described hardware platform, each device or IP building block is represented by a model. Thereby, the simulation is capable of describing the transaction flow between devices or IP building blocks. Accordingly, not only the output data of the simulation can be used to validate or to verify the hardware platform design but also the virtual transactions performed between the models represent the communication between devices or IP building blocks. Thus, a simulation with a plurality of models, each model representing a device or IP building block, is advantageous for an accurate reproduction of the hardware platform behavior.

In a simulation, two different types of models can be distinguished, namely a functional model and a cycle-based model.

The functional model only reproduces the function of a device or IP building block, omitting the implementation of relevant details (e.g., internal state information, a clock cycle representation, a predefined execution speed). The functional model is capable of replying to a transaction with an output. In particular, the functional model replies essentially instantaneously to a transaction initiator. The conception of functional models is easy as the implementation usually only consists of a static mapping of inputs to outputs. However, if the mapping is not static (e.g., functionally dependent), the conception of the functional model is more complex.

The cycle-based model is employed for reproducing the observable state of a device or IP building block in every cycle. Usually, a cycle-based model does not have a deterministic behavior, which means that there is no knowledge of the result of a transaction when the transaction is initiated. A cycle-based model is commonly designed to first collect all information regarding the transaction and then make the transaction progress up to the completion. Accordingly, a transaction is completed in a series of steps which are clocked corresponding to some clock frequency. Thus, for each clock cycle, the cycle-based model modifies its internal state progressing with the transaction. Consequently, a cycle-based model can provide a clock cycle accurate representation of the behavior of a hardware device implementing a device or IP building block.

As can be seen from the above, each of the two modeling approaches features an inherent design strategy which may be advantageously employed in different simulations. In particular, a simulation consisting of functional models exhibits a fast simulation speed and is easier to develop. Such a simulation, however, lacks accuracy in comparison with a cycle-based simulation. In contrast, a simulation consisting of cycle-based models is more accurate but usually has a slower simulation speed and is more complex to develop.

Thus, considering the advantages and disadvantages of a functional simulation and a cycle-based simulation, both simulations can be beneficially employed at different phases in the design process of a hardware platform. Usually, the functional models are used in an early design phase as functional models are developed more quickly. During testing there is usually the need for more accuracy, so every model needs to be rewritten to feature the cycle-based behavior.

The simulation library SystemC is known to provide a simulation engine for a joined hardware and software design. Commonly, the SystemC language is used for modeling clocked processes, namely by a simulation engine scheduling each process according to predefined time requisites. Further, the SystemC language also allows defining processes which are similar to functional models, as processes are not continuously triggered according to predefined clock cycles. In a simulation only containing blocks defining processes, the execution order of the simulation is determined by the sequence according to which information is transmitted between the processes.

The combination of both model types in one simulation results in a non-cycle-accurate simulation result. Further, when simulating concurrent transactions, additional precaution measures are needed for ensuring that each block operates according to the correct simulation timing. For this purpose, SystemC provides the concept of wait( ) operations. Thereby, the output of a functional model can be postponed for a variable number of simulation cycles in order to avoid data inconsistencies for concurrent transactions. Accordingly, a process block with a wait( ) operation behaves from the outside as cycle-based model, only with the difference of the block implementing a functional model.

A detailed description on SystemC is given, for instance, in IEEE Std 1666™-2005, “IEEE Standard SystemC® Language Reference Manual,” version 2.1, March 2006 (available at http://www.ieee.org and incorporated herein by reference).

Although the above-described implementation in the SystemC language allows for combining functional and cycle-based models, the implementation of functional models with wait( ) operations results in drawbacks. Due to the wait( ) operation, the functional model is made dependent from the simulation engine for scheduling the outputs, and the response of a functional model is delayed by the wait( ) operation resulting in the lengthening of the overall simulation time.

### SUMMARY

Embodiments of the present invention are a new simulation approach for simulating a multi-core hardware platform and improving the simulation speed while maintaining the simulation accuracy relative to a simulation of the same hardware platform, the devices of which are solely modeled by cycle-based models.

Embodiments of the present invention enable the use of functional models in a cycle-accurate simulation wherein the functional models still maintain functional properties (i.e., of responding immediately to a transaction).

Embodiments of the present invention allow for a flexible combination of functional and cycle-based models within a simulation.

Functional models are capable of immediately replying to a model initiating the transaction. Accordingly, replacing a cycle-based model with a functional model can speed up the execution of the simulation. However, functional models cannot be used within a cycle-accurate simulation where the cycles in the simulation must correspond to the cycles of the simulated hardware platform. Therefore, a first embodiment of the present invention extends purely functional models to timed-functional models capable of including a transaction time in the reply to a transaction. The returned transaction time indicates a delay which would have been introduced by a hardware device replying to the transaction. With the transaction time the transaction result of a functional model can be accurately timed by aligning and/or delaying the simulation results with respect to the main clock of the simulation. In comparison to a simulation of the same hardware platform where the devices are solely described by cycle-based models (and assuming the same level of accuracy of the models), this first embodiment of the present invention allows for a faster simulation speed due to the functional models replying immediately with a same time accuracy. Further, assuming a cycle-accurate description of a device modeled by a functional model, the provision of a transaction time enables the functional model to be used in a cycle-accurate simulation.

Another second embodiment of the present invention is to suggest the modification of the functional model such that it provides the same time information as a cycle-based model. According to this second embodiment of the present invention, the functional model is capable of immediately responding to a transaction with a result and a cycle count indicating how long the processing of the transaction would have taken for a hardware device. In other words, the functional model is capable of providing sufficient information to a cycle-accurate model acting as the transaction initiator such that the transaction initiator can align and/or delay the processing of the received information for a cycle-accurate simulation.

In an exemplary embodiment according to the first and second embodiments of the present invention, the functional model provides an execution time as an approximation of the transaction time which would have been necessary for the represented hardware device to execute the via transaction requested operation.

A further, third embodiment of the present invention is the modification of the functional model such that the cycle-based model and the functional model are interchangeably used in the simulation. In other words, the third embodiment adapts the functional and the cycle-based models such that both model types implement the same interface. Thereby, the simulation engine can switch between a functional model indicating the transaction time and a cycle-based model depending on an internal state of the simulation system. Alternately, the third embodiment implements both a functional and a cycle-based behavior for an operation. Thereby, the simulation engine is also enabled to determine the model behavior depending on an internal state of the simulation system.

One embodiment of the present invention is a computer-implemented method for simulating a multi-core hardware platform including a plurality of devices. Each device is represented in the simulation by either a functional model or a cycle-based model. The simulation system simulates the hardware platform by initiating a transaction by a model taking the role of a master model to request the execution of an operation by a model taking the role of a slave model, by executing the requested operation by the slave model, and by replying to the transaction by the slave model returning a result of the executed operation to the master model. In the case where the slave model is a functional model, the slave model in the simulation is adapted to execute the operation requested by the transaction and immediately reply thereto by returning the result of the executed operation and information on the execution time. The execution time indicates an estimated number of cycles of a main clock which the device represented by the functional slave model would have required for executing the operation.

In one exemplary implementation, a simulation engine of the computer-implemented method schedules the execution of the operation requested by the transaction and the reply thereto relative to the cycles of a main clock in case where the slave model is a cycle-based model.

Furthermore, the cycle-based models may define different execution cycles. For example, each cycle-based model has a predefined cycle T_{C} which is an integer multiple of the cycle T_{M} of the main clock. The simulation engine is scheduling the execution of an operation requested by a transaction and a reply thereto of each of the cycle-based models relative to the respective cycle T_{C}.

The master model may be a cycle-based master model. In this case, upon receipt of the reply to the transaction including the result and the information on the execution time, the master model is suspended for a number of cycles of the main clock corresponding to the execution time indicated in the received information.

In another exemplary embodiment of the present invention, the master model is a functional model and the master model is taking the role of a slave model for another master model representing a device of the simulated hardware platform, the other master model initiating another transaction for requesting the execution of an operation by the master model. In this case, upon receipt of the reply to the transaction including the result and the information on the execution time, the master model executes the operation requested by the other transaction and immediately replies thereto returning the result of the execution of the different operation and the sum of the received number of cycles and of the estimated number of cycles associated with the execution of the operation as information on the execution time.

In one exemplary embodiment of the present invention, the simulation engine is adapted to schedule the execution of an operation requested by a transaction and a reply thereto of each of the cycle-based models at different points in time within a cycle of the main clock.

In another exemplary embodiment of the present invention, the result which is returned by a slave model as a reply to a transaction requesting the execution of an operation indicates one of the following states: the COMPLETED state, where the operation is successfully completed; the PENDING state, where the operation is pending; and the ERROR state, where the execution of the operation results in an error.

In another exemplary embodiment of the present invention, the simulation engine is adapted to suspend a master model upon the master model receiving as a reply to a transaction requesting the execution of an operation of a slave model a result indicating a PENDING state.

Another alternative embodiment of the present invention also provides a computer-implemented method for simulating a multi-core hardware platform including a plurality of devices. Each device is represented in the simulation by either a functional model and/or a cycle-based model. At least one device of the hardware platform is represented by both a functional model and a cycle-based model. The functional model and the cycle-based model have a common interface. The simulation system simulates the hardware platform by initiating a transaction by a model taking the role of a master model to request the execution of an operation by one of the functional model and the cycle-based model representing the same device of the hardware platform, by determining according to an internal state of the simulation system which one of the two models is used as slave model for the device, by executing the requested operation by the determined slave model, and by replying to the transaction by the slave model returning a result of the executed operation to the master model.

A further alternative embodiment of the present invention also provides a computer-implemented method simulating a multi-core hardware platform including a plurality of devices. Each device is represented in the simulation by either a functional model and/or a cycle-based model. At least one device of the hardware platform is represented by a model including a cycle-based implementation of an operation and a functional implementation of the same operation. The simulation system simulates the hardware platform by initiating a transaction by a model taking the role of a master model to request the execution of an operation by a model taking the role of a slave model, the slave model including a cycle-based implementation of the requested operation and a functional implementation of the same operation, by determining according to an internal state of the simulation system which one of the two implementations is used by the slave model for executing the requested operation; by executing the determined implementation of the requested operation by the slave model, and by replying to the transaction by the slave model returning a result of the executed operation to the master model.

In one further exemplary embodiment of the present invention, the slave model in the simulation is adapted to execute the operation requested by the transaction and to immediately reply thereto by returning the result of the executed operation and information on the execution time in the case where the slave model is a functional model. The execution time indicates an estimated number of cycles of a main clock which the device represented by the functional slave model would have required for executing the operation.

A further alternative embodiment of the present invention relates to a computer program for executing a simulation of a multi-core hardware platform including a plurality of devices. Each device is represented in the simulation by either a functional model or a cycle-based model. The computer program when executed on a processor simulates the hardware platform by causing a model taking the role of a master model to initiate a transaction to request the execution of an operation by a model taking the role of a slave model, by causing the slave model to execute the requested operation, and by causing the slave model to reply to the transaction returning a result of the executed operation to the master model. In the case where the slave model is a functional model, the slave model executes the operation requested by the transaction and immediately replies thereto by returning the result of the executed operation and information on the execution time. The information on the execution time indicates an estimated number of cycles of a main clock which the device represented by the functional slave model would have required for executing the operation.

The computer-readable data medium according to an exemplary embodiment of the present invention stories instructions that, when executed by a processor of a simulation system, cause the simulation system to simulate a multi-core hardware platform including a plurality of devices. Each device is represented in the simulation by either a functional model or a cycle-based model. The instructions cause the simulation system to simulate the hardware platform by a model taking the role of a master model initiating a transaction to request the execution of an operation by a model taking the role of a slave model, by the slave model executing the requested operation, and by the slave model replying to the transaction returning a result of the executed operation to the master model. In the case where the slave model is a functional model, the slave model executes the operation requested by the transaction and immediately replies thereto by returning the result of the executed operation and information on the execution time. The information on the execution time indicates an estimated number of cycles of a main clock which the device represented by the functional slave model would have required for executing the operation.

Another exemplary embodiment of the present invention is providing a simulation system including a processor causing the simulation system to simulate a multi-core hardware platform including a plurality of devices, and a memory for storing intermediate simulation results. Each device is represented in the simulation by either a functional model or a cycle-based model. The simulation system simulates the hardware platform by a model taking the role of a master model initiating a transaction to request the execution of an operation by a model taking the role of a slave model, by the slave model executing the requested operation, and by the slave model replying to the transaction returning a result of the executed operation to the master model. In the case where the slave model is a functional model, the slave model executes the operation requested by the transaction and immediately replies thereto by returning the result of the executed operation and information on the execution time. The execution time indicates an estimated number of cycles of a main clock which the device represented by the functional slave model would have required for executing the operation.

A further alternative embodiment of the present invention relates to a computer program for executing a simulation of a multi-core hardware platform including a plurality of devices. Each device is represented in the simulation by either a functional model and/or a cycle-based model. At least one device of the hardware platform is represented by both a functional model and a cycle-based model. The functional model and the cycle-based model have a common interface. The computer program when executed on a processor simulates the hardware platform by causing a model taking the role of a master model to initiate a transaction to request the execution of an operation by one of the functional model and the cycle-based model representing the same device of the hardware platform, by causing the processor to determine according to an internal state of the simulation system which one of the two models is used as slave model for the device, by causing the determined slave model to execute the requested operation, and by causing the slave model to reply to the transaction returning a result of the executed operation to the master model.

The computer-readable data medium according to an exemplary embodiment of the present invention stores instructions that, when executed by a processor of a simulation system, cause the simulation system to simulate a multi-core hardware platform including a plurality of devices. Each device is represented in the simulation by either a functional model and/or a cycle-based model. At least one device of the hardware platform is represented by both a functional model and a cycle-based model. The functional model and the cycle-based model have a common interface. The instructions cause the simulation system to simulate the hardware platform by a model taking the role of a master model initiating a transaction to request the execution of an operation by one of the functional model and the cycle-based model representing the same device of the hardware platform, by the processor determining according to an internal state of the simulation system which one of the two models is used as slave model for the device, by the determined slave model executing the requested operation, and by the slave model replying to the transaction returning a result of the executed operation to the master model.

Another exemplary embodiment of the present invention is a simulation system including a processor causing the simulation system to simulate a multi-core hardware platform including a plurality of devices, and a memory for storing intermediate simulation results. Each device is represented in the simulation by either a functional model and/or a cycle-based model. At least one device of the hardware platform is represented by both a functional model and a cycle-based model. The functional model and the cycle-based model have a common interface. The simulation system simulates the hardware platform by a model taking the role of a master model initiating a transaction to request the execution of an operation by one of the functional model and the cycle-based model representing the same device of the hardware platform, by the processor determining according to an internal state of the simulation system which one of the two models is used as slave model for the device; by the determined slave model executing the requested operation, and by the slave model replying to the transaction returning a result of the executed operation to the master model.

A further alternative embodiment of the present invention relates to a computer program for executing a simulation of a multi-core hardware platform including a plurality of devices. Each device is represented in the simulation by either a functional model and/or a cycle-based model. At least one device of the hardware platform is represented by a model including a cycle-based implementation of an operation and a functional implementation of the same operation. The computer program, when executed on a processor, simulates the hardware platform by causing a model taking the role of a master model to initiate a transaction to request the execution of an operation by a model taking the role of a slave model, the slave model including a cycle-based implementation of the requested operation and a functional implementation of the same operation, by causing the processor to determine according to an internal state of the simulation system which one of the two implementations is used by the slave model for executing the requested operation, by causing the slave model to execute the determined implementation of the requested operation, and by causing the slave model to reply to the transaction returning a result of the executed operation to the master model.

The computer-readable data medium according to an exemplary embodiment of the present invention stores instructions that, when executed by a processor of a simulation system, cause the simulation system to simulate a multi-core hardware platform including a plurality of devices. Each device is represented in the simulation by either a functional model and/or a cycle-based model. At least one device of the hardware platform is represented by a model including a cycle-based implementation of an operation and a functional implementation of the same operation. The instructions cause the simulation system to simulate the hardware platform by a model taking the role of a master model initiating a transaction to request the execution of an operation by a model taking the role of a slave model, the slave model including a cycle-based implementation of the requested operation and a functional implementation of the same operation, by the processor determining according to an internal state of the simulation system which one of the two implementations is used by the slave model for executing the requested operation; by the slave model executing the determined implementation of the requested operation, and by the slave model replying to the transaction returning a result of the executed operation to the master model.

Another exemplary embodiment of the present invention is a simulation system including a processor causing the simulation system to simulate a multi-core hardware platform including a plurality of devices, and a memory for storing intermediate simulation results. Each device is represented in the simulation by either a functional model and/or a cycle-based model. At least one device of the hardware platform is represented by a model including a cycle-based implementation of an operation and a functional implementation of the same operation. The simulation system simulates the hardware platform by a model taking the role of a master model initiating a transaction to request the execution of an operation by a model taking the role of a slave model, the slave model including a cycle-based implementation of the requested operation and a functional implementation of the same operation, by the processor determining according to an internal state of the simulation system which one of the two implementations is used by the slave model for executing the requested operation; by the slave model executing the determined implementation of the requested operation, and by the slave model replying to the transaction returning a result of the executed operation to the master model.

### BRIEF DESCRIPTION OF THE DRAWINGS

In the following, embodiments of the present invention are described in more detail referring to the attached figures and drawings. Similar or corresponding details in the figures are marked with the same reference numerals.

FIG. 1 schematically shows an example of a multi-core platform and a simulation system to be used for the simulation according to an exemplary embodiment of the present invention,

FIG. 2 schematically shows simplified multi-core platform with shared devices according to an exemplary embodiment of the present invention,

FIG. 3 illustrates a simplified example of a hardware platform having only one initiator according to an exemplary embodiment of the present invention,

FIGS. 4A and 4B schematically shows an external interface for a transaction of a master model and of a slave model according to an exemplary embodiment of the present invention,

FIG. 5 illustrates an exemplary procedure for a cycle-based slave model to reply to a transaction according to an exemplary embodiment of the present invention,

FIG. 6 shows an exemplary timing diagram of a simplified “cache-miss” operation of an instruction cache taking the role of a master and a slave model according to an exemplary embodiment of the present invention,

FIG. 7 schematically shows the sequence of operations to be performed by a master model upon receipt of a reply to a transaction according to an exemplary embodiment of the present invention.

### DETAILED DESCRIPTION

Before describing embodiments of the present invention in more detail below, some definitions and conventions that are used in this document are first defined.

“Device”: The term device relates to a physical entity or logical entity of the hardware platform to be simulated. In some embodiments of the present invention, a device is a separate physical unit. However, it is also possible that a single physical entity is represented by multiple devices. For example, a cache may also be represented by multiple devices, e.g., one device representing the write buffer of the cache, another device representing the cache memory. In fact, the definition of a device within the simulation and its relation to the real-world hardware is up to the engineer designing the simulation models. Examples for devices are caches, memories, networks, buses, MMUs (memory management unit), etc., or logical or physical sub-units thereof.

“IP”: The term IP (or IP building block) is used as a synonym for a device herein, as previously mentioned above.

“Simulation System”: The term simulation system refers to a computing apparatus or computing system running the simulation. For example, in one embodiment of the present invention, the simulation system may be a general purpose computer. In another embodiment of the present invention, the simulation system is realized as any other type of computing apparatus, computing-like apparatus and/or hardware structure including at least a CPU, a mass storage component, a memory, and a user input/output device.

“Simulation Engine”: The term simulation engine refers to a piece of software for running a simulation. For example, the simulation engine may be a runtime environment of the simulation system. The tasks of the simulation engine may, for example, include one or more of the following: defining the start of the simulation; scheduling operations, e.g., transactions to be performed; and determining the termination of the simulation. Furthermore, the simulation environment may provide a simulation clock, also referred to as the main clock herein. All simulation operations are performed in accordance with the cycles of this main clock, e.g., the system clock of the simulation system.

“Cycle-Accurate Simulation”: The term cycle-accurate simulation is used to describe a simulation that ensures correct simulation results and timing by simulation models accurately handling transactions relative to the cycles of main clock. A cycle-accurate simulation is thus accurately reflecting the behavior of the simulated devices in terms of results and time. Each model may initiate a transaction, for example, for requesting an operation to be performed by another model. The initiating model puts the reply in an accurate time relationship to other transactions, by relating each transaction reply to the cycles of the main clock.

“Model”: A model represents a device or an IP of the hardware platform to be simulated. As each model may only provide a certain level of abstraction of the corresponding device or IP, there may be multiple different models for the same device or IP. Embodiments of the present invention distinguish at least the following types of models:

“Functional/Timed-Functional Model”: A functional model is a functionally accurate description of the behavior of a device or IP building block to the outside, without modeling of the internal implementation details of the represented device or IP (e.g., internal state information, a clock cycle representation, a predefined execution speed). This facilitates a functional model to reply to a request from a master model instantaneously. Further, the term “timed-functional” model indicates that results of the requested operation provided by the functional model additionally include a transaction time (i.e., the transaction time being the time between the reception and the result of a transaction). The transaction time indicates the time that the execution of the requested operation and the response of the execution result would have taken on the simulated device or IP being represented by the timed-functional model. The transaction time may be expressed in cycles of the main clock and may be approximated by the execution time of executing the requested operation.

“Cycle-based model”: A cycle-based model is designed to reproduce the observable state of a device or an IP block in every cycle. A cycle-based model does not have a deterministic behavior as there is no knowledge of the output/result of a transaction when the transaction is initiated. Accordingly, a transaction is completed in a series of steps which are scheduled, for example, corresponding to the predefined cycle ratio of the represented device. Thus, for each predefined cycle, the internal state of the cycle-based model is modified.

“Transaction”: The term transaction refers to the operations to be performed between two models. A first model initiates the transaction to a second model and the second model responds to said transaction. To indicate the role of each model, a model taking the role of the transaction initiator is called master model, and a model receiving and replying to the transaction is called slave model. In order to reply to a transaction the slave model may execute computations. As models can take the role of a master model as well as the role of a slave model for different transactions, the master and the slave property is defined with respect to a given transaction. The terms master IP and slave IP are used similarly as the terms master model and slave model.

“Immediate reply”: The term immediate reply means that a slave model responds to a transaction within one clock cycle of the main clock. Hence, the request for the transaction from a master model and the response thereto by the slave model must be provided within the same clock cycle of the main clock.

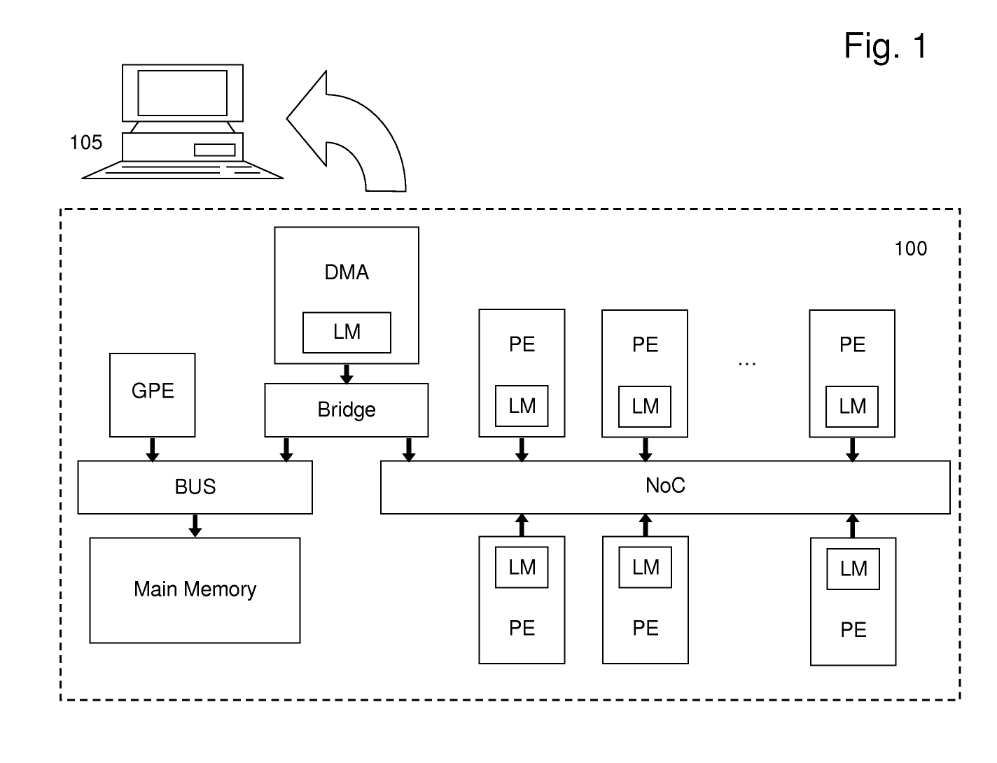

Referring now to FIG. 1, an exemplary multi-core hardware platform 100 and a simulation system 105 is depicted.

The simulation system 105, shown in FIG. 1, is a computing device capable of running a program defining the simulation method as set out below. In particular, the simulation system 105 of FIG. 1 is depicted as a general purpose computer only in terms of an illustrative example. Alternatively, the simulation system 105 could be any other kind of computing device, computing-like device and/or hardware structure composed by a CPU, a storage medium, a memory, a user input/output device and the like.

As indicated by the arrow, embodiments of the present invention relate to the simulation system running a simulation of models representing the hardware platform 100. Usually, the simulation is provided as a program written in a programming language. Accordingly, the simulation method includes models which implement the functionality of the represented devices or IP building blocks. Each model may, for instance, implement an operation which a different model may request to be executed (e.g. a memory model may implement a read( ) function to be executed by different model). Upon receiving of a request for executing an operation, the model may execute its operation e.g. within its own namespace.

In particular, such a request for executing an operation may be realized as a function call of the operation provided by a model. However, to be formally correct, the above wording has only been introduced for simplicity. The description should be understood such that the processor of a simulation system executes all operations, and that a simulation engine or a kernel is provided by the simulation method which performs the scheduling of the execution of operations and other time related operations (e.g. callback mechanism). Nevertheless, a description with models executing operations is chosen as it is coherent with the execution of operations by the (hardware) devices to be simulated.

In the simulation according to embodiments of the present invention, two types of models are combined, namely functional models and cycle-based model. Functional models have the advantage of immediately replying to a transaction requesting the execution of an operation (i.e. replying within the same clock cycle of the simulation). This advantage results from an implementation of a functional model that is not time dependent. Cycle-based models are scheduled according to a predefined cycle by the simulation engine.

In order to allow the cooperation of the cycle-based models and the functional models, the functional models are adapted to reply with a result to a transaction including a transaction time (i.e. the transaction time being the time between the reception and the reply of a transaction). However, to implement a simulation with functional models replying with a result including the transaction time, the transaction initiator models (i.e. master models) have to be adapted. For example, the transaction initiator models may be suspended upon receipt of the transaction time. In the case where a transaction initiator model initiates two transactions: one to a functional slave model (which would have taken e.g. 4 cycles for the execution) and another to a cycle-based slave model (which takes e.g. 4 cycles for the execution), the temporary suspending of the transaction initiator model may be the only option for both results to arrive at the same time.

Further, the suspending of a transaction initiator model receiving reply to a transaction with a transaction time may be realized in cycle-based slave models. In general, cycle-based models have no deterministic behavior. Accordingly, while executing the simulation of a cycle-based model, there is no deterministic knowledge of how the model will progress until completion. Accordingly, the simulation of a cycle-based model is modified to suspend the cycle-based model when receiving a transaction result and a transaction time indicating the completion of a transaction for a future point in time.

Alternately, a transaction initiator model may propagate the received transaction time in an upward direction of transaction dependent models. This concept can be advantageously realized in transaction initiator models which are functional models. For instance, in the case of three transaction dependent functional models, namely a first functional model initiating a first transaction to a second functional model whereupon the second functional model is initiating a dependent transaction to a third functional model, the first functional model may receive a reply to the initiated transaction including time information corresponding to the sum of the time for the first transaction and of the dependent second transaction.

In particular, a functional model immediately responds to a transaction, namely within the same clock cycle. Accordingly, a functional model also receives a transaction result and a transaction time and replies to another transaction within the same clock cycle. Thus, the sum of the receive transaction time plus the transaction time for responding to the other transaction corresponds to the cycles of the main clock which the two transactions would have taken in the represented (hardware) devices to be executed.

Furthermore, the simulation according to embodiments of the present invention also enables a dynamically changeable cooperation of the models. Normally, each device of the hardware platform to be simulated is represented by one model, namely a functional or a cycle-based model. However, there are simulation embodiments of the present invention for which one or the other implementation is preferable.

Accordingly, the simulation is capable of handling a functional and a cycle-based model representing the same device to be simulated. For this purpose, the cycle-based and the functional model have the same transaction interface. The simulation engine dynamically determines depending on an internal state, which of the two models is used in the simulation for representing the device. The internal state may be set by a user for the whole duration of the simulation. Alternately, a user may also specify models to be changed depending on a predefined clock cycle of the simulation clock.

Alternately, the simulation is capable of handling a model including a functional and a cycle-based implementation of the same operation to be requested for execution by a transaction. In this case, the simulation engine dynamically determines according to an internal state which of the two implementation of the same operation is executed by the model upon receiving a request for execution of the operation. The internal state may be set by a user for the whole duration of the simulation. Alternately, a user may also specify models to be changed depending on a predefined clock cycle of the simulation clock.

Further, the hardware platform 100 of FIG. 1 shows a platform with several transactions initiators, in particular a DMA and several other initiators, i.e. hardware accelerators or programmable hardware accelerators PE (Processing Elements). Furthermore, the hardware platform 100, comprises replying devices like for example a BUS, a Main Memory, a NoC (“Network-on-Chip”) and a bridge. As illustrated in FIG. 1, the transaction initiators are connected to the replying devices and at least some of the replying devices are shared amongst several initiators, this applies for example to the replying device BUS. This exemplary multi-processor platform is preferably composed of a GPE, and a regular array of PE processors or hardware accelerators. Each processor (or hardware accelerator) has its own distributed but uniform memory address space.

The hardware platform 100 of FIG. 1 can be an example of a generic multimedia streaming multi-core platform, which is becoming common not only in standalone devices (DVD or Blu-ray players, set-top boxes, etc.) but also in mobile devices (mobile phones, smart phones, etc.).

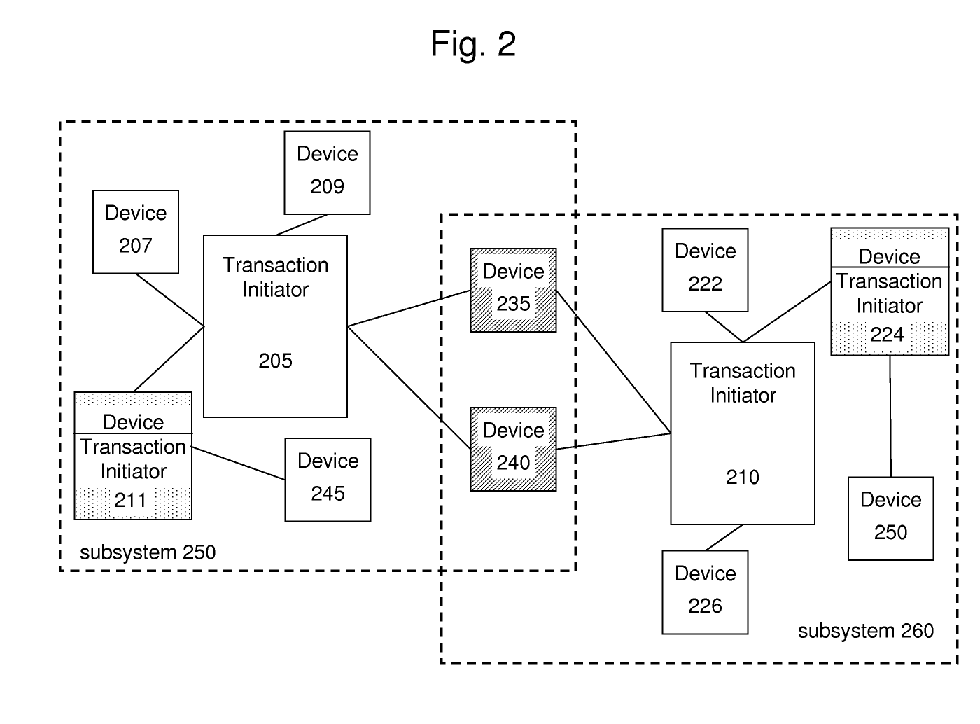

Turning now to FIG. 2, a basic architecture of a hardware platform as outlined by FIG. 1 is illustrated in a simplified manner.

Referring now to FIG. 2, a hardware platform is shown as an abstract model of electronic components 205 to 250 that are interconnected with each other by means of data connection which can for example be an electronic wire, a bus or a network, and the like. As an illustrated example, the combination of devices and the characteristics of the data connections depicted in FIG. 2 have an exemplary character with respect to embodiments of the present invention. Therefore, the principles of embodiments of the present invention can be applied to any hardware platform including different numbers of devices or different kinds of data connections.

In FIG. 2, transaction initiators 205/210 are illustrated to connect to devices 207-240. In particular, transaction initiator 205 is connected to five devices, namely devices 207 to 211, and devices 235 and 240. The transaction initiator 205 with its connected devices forms a subsystem 250. Similarly, transaction initiator 210 is connected to devices 222 to 226 and devices 235 and 240, thus forming a subsystem 260.

Further, devices 211 and 224 have additional connections for which the devices 211 and 224 take the role of a transaction initiator. In particular, device 211 takes the role of a transaction initiator for the connection to device 245 and device 224 takes the role of a transaction initiator for the connection to device 250. The connection between devices 211/224 and devices 245/250 enable the transaction initiators 205/210 to indirectly communicate with devices 245/250. However, as devices 211/224 are connected in between the transaction initiators 205/210 and devices 245/250, the transaction initiators 205/210 cannot directly initiate a transaction to devices 245/250.

Depending on the functionality of a model, a model may implement the role of either a transaction initiator, namely master model, or of a replying device, namely slave device, or may alternately implement both roles, namely the role of a transaction initiator for a first set of transactions and the role of a replying device for a second set of transactions.

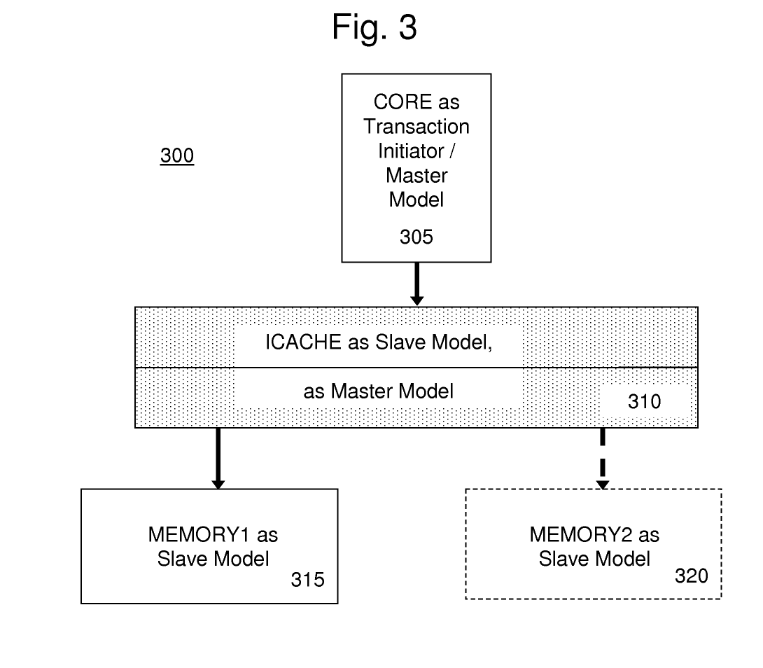

Referring now to FIG. 3, a simplified model of the hardware platform 300 to be simulated is shown. The exemplary hardware platform 300 comprises a processing element named core model 305, an instruction cache model 310 and two memory models 315 and 320. In this example, the memory model 320 is optional.

For core model 305 to run a program executing instructions, the core model fetches an instruction from a memory model 315 or 320, the instruction identifying operator and operands of a program. In particular, core model 305 includes an instruction pointer register which determines a next instruction to be executed corresponding to a sequence of the program. In the described hardware platform, additionally an instruction cache model 310 is provided for speeding-up the instruction fetch operation of core model 305.

Generally, the instruction cache 310 is optimized for accessing the stored information fast. Thus, in the simulation the cached instructions can be read faster from the instruction cache model 310 than from the memory model 315 or 320 storing the program. However, an instruction cache model only holds a subset of instructions with respect to the whole program. Accordingly, upon core model 305 initiating an instruction fetch operation, the instruction cache model 310 first needs to determine whether the instruction to be fetched is present and/or valid in instruction cache model 310.

In the case where the instruction to be fetched is present, namely a cache-hit, the instruction cache model 310 copies the requested instruction to a specified address, for instance, the register of the core model 305 supplying the next instruction. Thereafter, the instruction cache model 310 is replying to the instruction fetch operation of core model 305 indicating a COMPLETED state.

In the case where the instruction to be fetched is not present, namely a cache-miss, the instruction cache model 310 redirects the instruction fetch operation to the memory model including the program. For this purpose, the instruction cache model 310 initiates a transaction requesting an execution of an instruction read operation by the memory model 315 or 320. Due to the delay introduced as latency by the memory model 315 or 320, the instruction cache model responds to the transaction initiator core model after a time corresponding to the sum of the time necessary for the cache-miss operation and the latency of the (hardware) memory.

In more detail, after the latency of the memory elapses, the memory model 315 or 320 is copying the read instruction to some address. Upon receipt of the result of the instruction read operation, the instruction cache model 310 is capable of updating the cached instructions. At the same time the cache model 310 is copying the requested instruction to a specified address, for instance, the register of the core model 305 supplying the next instruction and replying indicating a COMPLETED state.

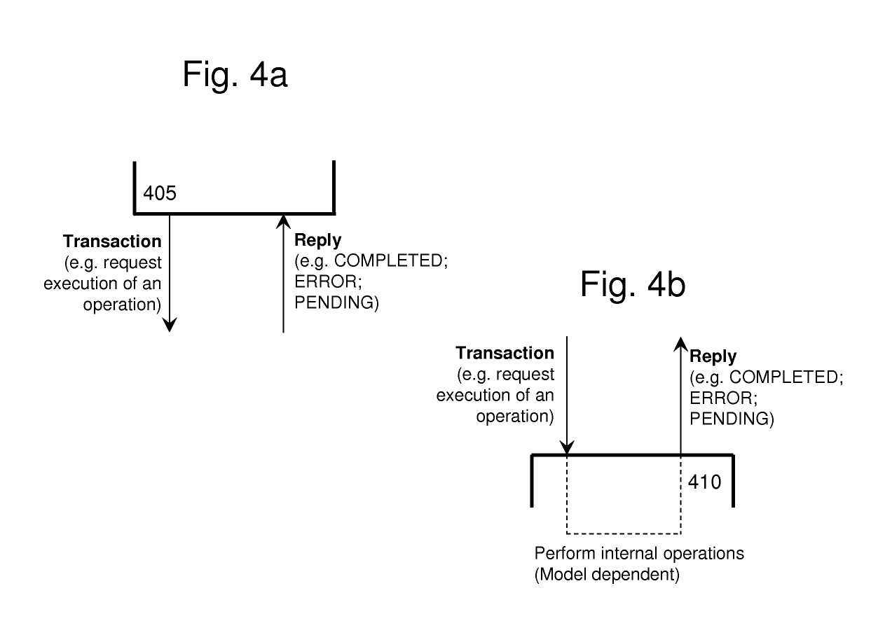

Referring now to FIGS. 4a and 4b, the interfaces of a master model 405 and a slave model 410 are shown, enabling the master and the slave model to initiate/reply to a transaction.

As shown in FIG. 4a, the interface of the master model 405 is capable of initiating a transaction. The transaction may be used for requesting the execution of an operation. As an example, a CPU, taking the role of the master model 405, can request a cache to provide the next instruction. Further, the interface of the master model 405 also defines a reply to a transaction. For example, the reply may indicate one of the following states COMPLETED, ERROR and PENDING, where the COMPLETED state defines that the operation is successfully completed; the PENDING state defines that the operation is pending, and the ERROR state defines that the execution of the operation has resulted in an error.

As shown in FIG. 4b, the interface of the slave model 410 is capable of receiving a transaction. A transaction to a slave model 410 may request an operation of the slave model to be executed. Accordingly, upon the slave model 410 receiving a transaction requesting an operation of the slave model 410 to be executed, the slave model 410 processes the requested operation. Slave models may provide different operations, for example a cache model may provide a cache read operation, a memory may provide a memory read and a memory write operation. An operation which is requested to be executed by a master model may also cause a dependent operation/multiple dependent operations to be executed. For example, a memory write operation may also cause the respective data to be invalidated in a cache.

Upon completion of the execution of the requested operation by the slave model 410 and the completion of other, dependent operations by other models, the interface of the slave model defines the reply to indicate the COMPLETED state. Further, if the operation or any dependent operation cannot be immediately processed (e.g. the slave model is a cycle-based mode) the interface of the slave model defines the reply to indicate a PENDING state. If any transaction results in an error, the interface of the slave model defines the reply to indicate an ERROR state.

In this exemplary embodiment of the present invention, there is no distinction between a functional master model or a cycle-based master model, or between a functional slave model or a cycle-based slave model because all master models and all slave models implement the same transaction interface. In particular, the functional master model and the cycle-based master model implement the same interface, namely the interface illustrated by FIG. 4a. Further, the functional slave model and the cycle-based slave model implement the same interface, namely the interface illustrated by FIG. 4b.

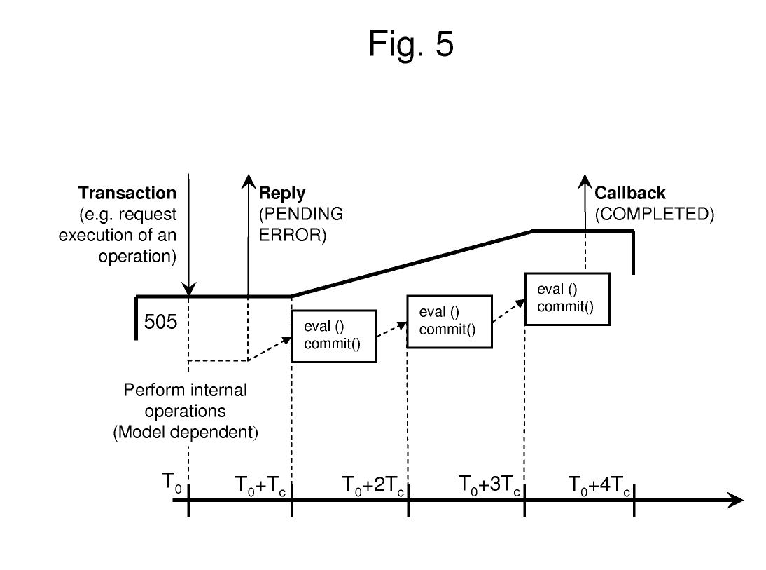

Referring now to FIG. 5, the procedure of executing a requested operation in a cycle-based slave model 505 is shown.

The slave model shown in FIG. 5 is a cycle-based model. In contrast to a functional slave model for which a received transaction triggers the execution of a requested operation and the reply to the transaction, in the cycle-based model, the execution is timed according to a main clock which can be e.g. the system clock or a pre-scaled system clock or a different timing mechanism.

When a transaction is received by the cycle-based slave model 505 at time point T₀, the cycle-based slave model registers the transaction as pending transaction for scheduling the execution of the requested internal operations. The scheduling is performed by a simulation engine. Upon a successful registration of the received transaction as a pending transaction, the cycle-based slave model replies to the transaction initiator indicating a PENDING state. In the case where there is an error in the transaction, the reply to the transaction initiator indicates an ERROR state. An error may result from, for example, a reference to an address where there is no devices mapped onto, or if the size (number of bytes involved in the transfer) is not supported by the slave device.

The reply to the transaction indicating the PENDING state is immediately transmitted by the cycle-based slave model 505 to the master model requesting the execution of the operation, namely within the same clock cycle T_{C}. With the reply, the control is handed over to the master model by a return operation indicating the PENDING state.

Due to the cycle-based slave model 505 registering the transaction as a pending transaction, the simulation engine of the simulation system starts scheduling the execution of the requested operation at time point T₀+T_{C}. The scheduling is performed in two steps.

First, the simulation engine calls the eval( ) function of the cycle-based slave model 505 e.g. for collecting the inputs for the requested operation. Within the eval( ) operation, also other computations may be performed by the cycle-based slave model 505. However, within the eval( ) function the observable state of the cycle-based slave model 505 must not be changed.

Thereafter, the simulation engine calls the commit( ) function for changing the observable state of a cycle-based slave model 505. Thus, the processing of the eval( ) function has completed when the commit( ) function of the cycle-based slave model 505 is scheduled to be executed. As an example, the commit( ) function of a cycle-based slave model may copy bytes from a memory to some predefined address or trigger a callback mechanism.

In the simulation of embodiments of the present invention, the cycle-based models employ the eval( ) and the commit( ) function in order to simulate a rising clock edge triggering the devices that operate in parallel. The cycle-based models are scheduled. The scheduling consecutively processes registered pending transactions. To avoid the destruction of input data by a cycle-based model modifying an accessible state, the processing of each transaction is separated in the eval( ) and in the commit( ) function which are scheduled by the simulation engine consecutively. Accordingly, the simulation engine first executes the eval( ) function of all registered transactions for the cycle-based models before executing the commit( ) function of all registered transactions.

In the example of a cycle-based slave model 505 shown in FIG. 5, the simulation engine schedules eval( ) and commit( ) function for three cycles T_{C}, namely at time points: T₀+T_{C}, T₀+2T_{C}, T₀+3T_{C} During the third execution of the commit( ) function, namely at time point T₀+3T_{C}, the result to the transaction is determined. Thereupon, the cycle-based slave model employs a callback mechanism to use a callback function to return to the transaction initiator model with a result indicating a COMPLETED state. Upon successful completion, the transaction is deregistered from execution for the cycle-based slave model.

In particular, the simulation employs the callback mechanism for a cycle-based slave model to reply to the master model initiating the respective transaction. As the cycle-based slave model has already returned by indicating the PENDING state, the callback mechanism provides a different, asynchronous method for transferring the control back to the master model. In particular, a master model passes upon initiation of a transaction a function pointer to a callback function to be processed, upon completion of the transaction by the slave model. The function pointer can be used by the slave model to communicate to the initiator model that the transaction is finished.

As becomes apparent from the above description regarding FIG. 5, each cycle-based model is capable of registering and deregistering to a simulation engine to schedule the execution of a transaction requesting a specific operation to be executed. The cycle T_{C} according to which the execution of the transaction is scheduled determines the execution frequency. A cycle-based model may have different execution frequencies. Accordingly, each cycle-based model has a predefined cycle T_{C} which is an integer multiple of the cycle T_{M} of a main clock. In particular, the cycle main clock T_{M} is defined such that T_{M}=N·T_{C} is true for the T_{C} of all cycle-based models and N is an integer≧1.

Although not illustrated in FIG. 5, multiple transactions may be registered to be scheduled by the simulation engine for one cycle-based model.

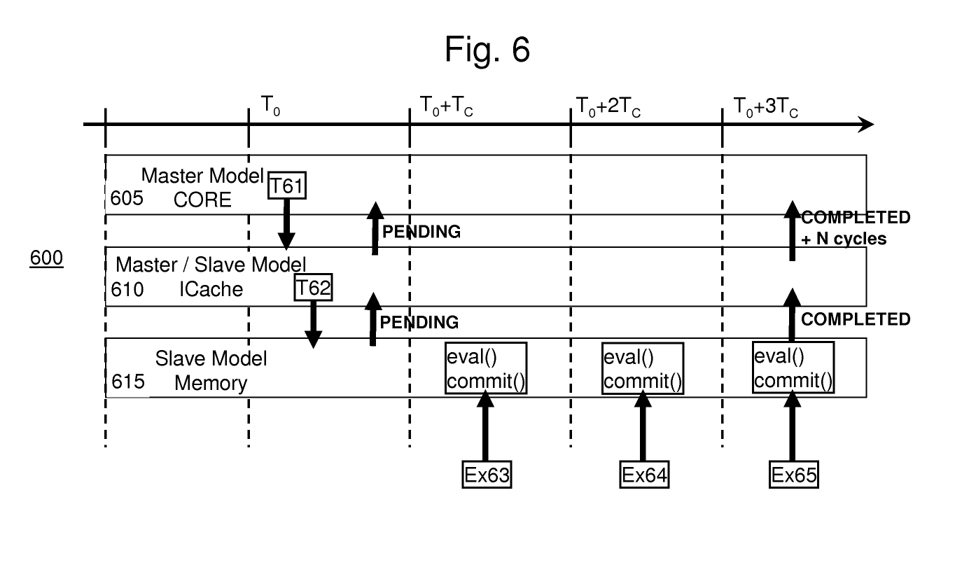

Referring now to FIG. 6, an exemplary timing diagram of a simplified cache-miss operation by an instruction cache taking the role of a master and a slave model is shown. This example also illustrates the timing regarding the cache-miss operation introduced with respect to FIG. 3.

As can be seen from FIG. 6, at time point T₀, core model 605 is initiating transaction T61 requesting an instruction fetch operation to instruction cache model 610. The instruction cache model 610 is realized in this example as a functional model. Accordingly, instruction cache immediately determines if the requested instruction is present in the cache. In the example, the requested instruction is not present (or not valid) in the instruction cache model 610. Thus, instruction cache model 610 initiates transaction T62 requesting an instruction read operation to memory model 615.

The memory model 615 of this example is realized as a cycle-based model. Accordingly, the memory model 615 receives the transaction requesting the instruction read and registers this PENDING transaction to be scheduled by the simulation engine. Within the same clock cycle T_{C}, the memory model 615 replies to the cache model 610 indicating a PENDING state. Due to the cache model 610 receiving the reply indicating PENDING operation, the cache model 610 is suspended until a callback to the cache model 615 is triggered. For suspending a functional model, the parameters of a functional model are saved. Additionally the functional model replies to its transaction initiator, in this example the core model 605, indicating also the PENDING state.

Due to the memory model 615 registering the transaction requesting the execution of an instruction read operation, the simulation engine—in the example the latency of the memory model corresponds to three cycles—schedules for the three consecutive cycles T₀+T_{C}, T₀+2T_{C}, and T₀+3T_{C} the execution Ex63, Ex64 and Ex65, of first an eval( ) and then a commit( ) function.

At time point T₀+3T_{C}, the execution of the commit( ) function of the memory model 615 results in a completion of the instruction read operation. Accordingly, the memory model 615 copies the requested instruction to some address of the instruction cache 610. Additionally, the memory model 615 employs the callback mechanism to reply to the instruction cache indicating a COMPLETED state. Upon receipt of the result indicating the completion of the instruction read operation, the instruction cache model 610 may update the cached instructions. At the same time the instruction cache model 610 is copying the requested instruction to a specified address, for instance, the register of the CORE model 605 supplying the next instruction and replying thereto also via callback mechanism indicating a COMPLETED state. Since the instruction cache model 610 is a functional model, the reply includes time information on the time which the execution of the requested cache read operation would have taken for a (hardware) device. In the example, the reply includes time information indicating additional N cycles.

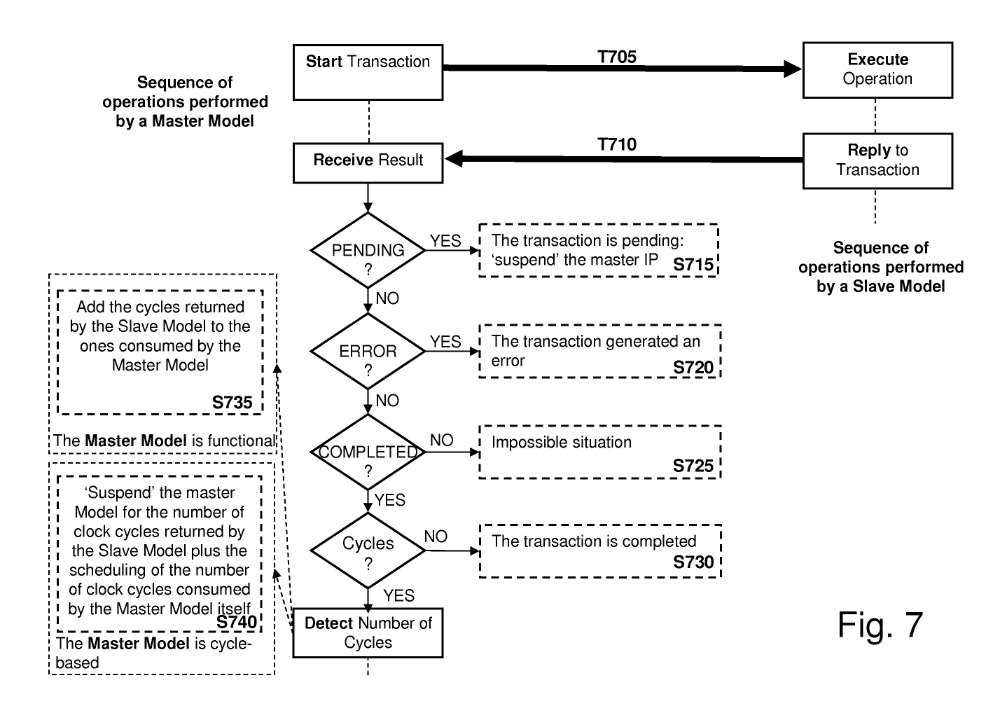

Referring now to FIG. 7, a sequence of operations to be performed by a master model upon receipt of a result as a reply to a transaction is shown.

As shown in FIG. 7, the master model on the left side initiates a transaction T705 requesting the execution of an operation to a slave model on the right side. Thereupon, the slave model executes the requested operation and replies to the transaction T710 including a result of the requested operation.

Upon receipt of the transaction T710 including the result of the requested operation, the master model determines if the result indicates a PENDING state. If the result is determined to indicate a PENDING state (YES), the master model is suspended until the callback mechanism is triggered for the master model (step S715).

If the master model determines that the result does not indicate a PENDING state (NO), the master model determines if the result indicates an ERROR state. If the result is determined to indicate the ERROR state (YES), the transaction generated an error and the master model may perform error handling to recover the erroneous state in the slave model (step S720).

If the master model determines that the result does not indicate an ERROR state (NO), the master model determines if the result indicates a COMPLETED state. A result of the determining operation that the result of the transaction does not indicate the COMPLETED state is an impossible situation (S725).

If the result is determined to indicate the COMPLETED state (YES), and if the result is determined not to include a number of cycles (NO), the execution of the requested operation is indicated to have successfully completed (step S730). Thereafter, the master model continues processing operations.

If the result is determined to indicate the COMPLETED state (YES), and if the result is determined to include a number of cycles (YES), the master model detects the number of cycles to be included by the slave model in the reply to the transaction requesting the execution of an operation.

If the master model is a functional model, the master model adds the number of cycles received from the slave model to a number of cycles consumed by the master model for previous operations (step S735). The sum of a received number of cycles and the internal number of cycles may be included in a response to a transaction where the master model is taking the role of a slave model.

If the master model is a cycle-based model, the master model is suspended for the number of clock cycles returned by the slave model plus the number of cycles consumed by the master model itself (step S740).

In order to further illustrate the advantages of the simulation according to the different embodiments of the present invention, an example of a core model, of an instruction cache model and of a memory model is provided in a pseudo code language. These models only implement a minimum of functionality and are incorporated to illustrate the instruction and data flow between models. In the following, first a core model is described, thereafter an instruction cache model and last a memory model is introduced.

The following Source Code Block 1 illustrates an exemplary implementation of a cycle-based model according to first and second embodiments of the present invention. In particular, the source code block 1 describes a core model in line with the core model 305 of the exemplary embodiment of FIG. 3 and the core model 605 of the exemplary embodiment of FIG. 6.

| | |
|---|---|
| 1 | void reset( ) |
| 2 | { |
| 3 | current_stage = 0; |
| 4 | } |
| 5 | |
| 6 | |
| 7 | void clock_eval( ) |
| 8 | { |
| 9 | /* not necessary in this simple example */ |
| 10 | } |
| 11 | |
| 12 | /* one stage per clock cycle, unless in the case of stalls */ |
| 13 | void clock_commit( ) |
| 14 | { |
| 15 | byte buffer[4]; /* 32-bit instructions */ |
| 16 | |
| 17 | ret = COMPLETED; |
| 18 | |
| 19 | switch (current_stage) |
| 20 | { |
| 21 | case 0: |
| 22 | ret = fetch(PC, buffer, fetch_callback); |
| 23 | break; |
| 24 | |
| 25 | case 1: |
| 26 | inst = decode(buffer); |
| 27 | break; |
| 28 | |
| 29 | case 2: |
| 30 | ret = exec(inst, exec_callback); |
| 31 | break; |
| 32 | |
| 33 | default: |
| 34 | assert(0); |
| 35 | } |
| 36 | |
| 37 | if ((ret is COMPLETED) \|\| (ret is ERROR)) |
| 38 | { |
| 39 | if (ret is ERROR) |
| 40 | { |
| 41 | current_stage = 0; /* abort instruction */ |
| 42 | |
| 43 | treat_error( ); /* e.g. raise exception */ |
| 44 | } |
| 45 | else |
| 46 | { |
| 47 | /* go to the next pipeline stage */ |
| 48 | current_stage++; |
| 49 | |
| 50 | if (current_stage == 3) |
| 51 | { |
| 52 | commit_instruction(inst); |
| 53 | |
| 54 | current_stage = 0; |
| 55 | } |
| 56 | } |
| 57 | } |
| 58 | else |
| 59 | { |
| 60 | /* it is useless to be clocked if we have to wait for a |
| 61 | transaction to complete, and this will happen when one of the two |
| 62 | callbacks is called, and the callback will reactivate the clock */ |
| 63 | suspend_clock( ); |
| 64 | } |
| 65 | } |
| 66 | |
| 67 | |
| 68 | mem_ret_t fetch(address, buffer, callback) |
| 69 | { |
| 70 | mem_ret_t ret = next_device->read(address, buffer, callback); |
| 71 | |
| 72 | if (ret is PENDING) |
| 73 | { |
| 74 | save_params(address, buffer, callback); |
| 75 | } |
| 76 | |
| 77 | return ret; |
| 78 | } |
| 79 | |
| 80 | |
| 81 | inst decode(buffer) |
| 82 | { |
| 83 | return_instruction_encoded_in_buffer( ); |
| 84 | } |
| 85 | |
| 86 | |
| 87 | mem_ret_t exec(inst, callback) |
| 88 | { |
| 89 | if ((inst is LOAD) \|\| (inst is STORE)) |
| 90 | { |
| 91 | mem_ret_t ret; |
| 92 | |
| 93 | if (inst is LOAD) |
| 94 | { |
| 95 | ret = next_device->read(inst->address, inst->buffer, |
| | inst->callback); |
| 96 | } |
| 97 | else if (inst is STORE) |
| 98 | { |
| 99 | ret = next_device->write(inst->address, inst->buffer, |
| | inst->callback); |
| 100 | } |
| 101 | |
| 102 | if (ret is PENDING) |
| 103 | { |
| 104 | save_params(inst->address, inst->buffer, inst->callback); |
| 105 | } |
| 106 | |
| 107 | return ret; |
| 108 | } |
| 109 | else |
| 110 | { |
| 111 | /* in this case we suppose the instruction does not involve any |
| 112 | memory operations */ |
| 113 | execute_inst(inst); |
| 114 | |
| 115 | return COMPLETED(0); |
| 116 | } |
| 117 | } |
| 118 | |
| 119 | |
| 120 | void fetch_callback(mem_ret_t ret) |
| 121 | { |
| 122 | /* perform all other operations needed when completing the |
| | fetch stage */ |
| 123 | |
| 124 | /* go to the next pipeline stage */ |
| 125 | current_stage = (current_stage + 1) % 3; |
| 126 | |
| 127 | reactivate_clock( ); |
| 128 | } |
| 129 | |
| 130 | |
| 131 | void exec_callback(mem_ret_t ret) |
| 132 | { |
| 133 | /* perform all other operations needed when completing the |
| | execution stage */ |
| 134 | |
| 135 | /* go to the next pipeline stage */ |
| 136 | current_stage++; |
| 137 | |
| 138 | if (current_stage == 3) |
| 139 | { |
| 140 | commit_instruction(inst); |
| 141 | |
| 142 | current_stage = 0; |
| 143 | } |
| 144 | |
| 145 | reactivate_clock( ); |
| 146 | } |

### Source Code Block 1

A core in the hardware platform to be simulated can be understood as a processing unit. The core fetches an operation, decodes the fetched operation and then executes the decoded operation. The instructions are normally provided from an instruction cache or a memory holding the program.

The core model of Source Code Block 1 also realizes the same sequence of operations as a cycle-based model. In particular, the pseudo code model of Source Code Block 1 with an implementation of a core model distinguishes between three stages for the fetch, decode, and execute operation. For this purpose, the cycle-based core model comprises a state variable named current_stage. During initialization or for a system reset the state variable current_stage is reset (cf. Source Code Block 1, lines 1-4).

During simulation, the simulation engine executes for every registered cycle-based model the eval( ) and the commit( ) function in a schedule corresponding to a predefined cycle T_{C}. In the particular case, the functions are called clock_eval( ) and clock_commit( ) The clock_eval( ) function of the core model is empty (cf. Source Code Block 1, lines 7-10). The clock_commit( ) function determines first the next stage to be processed and executes the according function, namely the fetch( ), the decode( ) or the exec( ) function (cf. Source Code Block 1, lines 19-35).

As for instance the fetch( ) function of the core model initiates a transaction requesting the execution of an instruction fetch operation by an instruction cache, the clock_commit( ) function also includes a section (cf. Source Code Block 1, lines 37-65) for distinguishing and/or processing the result received as a reply to the initiated instruction. In particular, the core model distinguishes, if the received result indicates the COMPLETED state, between the different stages the core model can be. If the core model is in the fetch or the decode stage, a result indicating a COMPLETED state results in the core model proceeding to the next stage. If the core model is in the execute stage, a result indicating a COMPLETED state results in the core model first executing a commit_instruction( ) function before proceeding to the first stage, namely the fetch stage (cf. lines 37-57). In the case where the received result indicates an ERROR state, the core model performs error handling and aborts the processing of last instruction.

Only if the received result indicates a PENDING state, the scheduling by the simulation engine is interrupted and the core model is suspended (cf. Source Code Block 1, lines 58-65). By a PENDING state a slave model to which a transaction requesting the execution of an operation has been initiated indicates that the execution has not completed. In hardware, a core would stall issuing NOP-operations. Yet, in the simulation, the core model can be suspended, reducing the simulation load. For resuming after a suspended state with the stage the core model was previously executing, two of the three functions of the core model, namely the fetch( ) and the exec( ) function, have an associated callback function, namely fetch_callback( ) and exec_callback( )

Specifically, the fetch stage, implemented by the fetch( ) function in the core model of Source Code Block 1, issues a read operation to the next device (cf. Source Code Block 1, line 71). This next device can be, for example, a model of an instruction cache. In this case, the next device is replying with a result indicating the PENDING state, the parameters are saved (cf. Source Code Block 1, lines 73-77), and the core model is suspended (cf. Source Code Block 1, line 64). In the case where the next device is replying with a result indicating the COMPLETED state, the core model proceeds to the next stage.

Further, the decode stage, implemented by the decode( ) function in the core model returns the instruction encoded in a buffer (cf. Source Code Block 1, lines 82-85).

The execute stage, implemented by the exec( ) function in the core model of Source Code Block 1, distinguishes between load/store operations and other operations. In particular, if the decoded instruction is determined to either be LOAD or STORE the corresponding transaction to a next device is initiated, namely for requesting the execution of a load or a store operation. For the example, the next device is a memory-like device. In this case, the next device is replying with a result indicating the PENDING state, the parameters are saved (cf. Source Code Block 1, lines 103-106), and the core model is suspended (cf. Source Code Block 1, line 64). In this case, the next device is replying with a result indicating the COMPLETED state, the core model proceeds to the next stage. Alternately, other instructions are executed by the execute_inst( ) function (cf. Source Code Block 1, line 114).

For the callback mechanism of a cycle-based model, the core model provides two associated callback functions, namely fetch_callback( ) and exec_callback( ) The fech_callback( ) function proceeds to the next stage of the core model and executes the reactivate_clock( ) function which reactivates the scheduling by the simulation engine according to the predefined cycle T_{C} (cf. Source Code Block 1, lines 121-129). Similarly, the exec_callback( ) function increments the stage counter to proceed to the next stage and if the core model is determined to proceed with the fetch stage, the exec_callback( ) function also executes a commit_instruction( ) function. Further, the core model also executes the reactivate_clock( ) function which reactivates the scheduling by the simulation engine according to the predefined cycle T_{C} (cf. Source Code Block 1, lines 133-149).

The exemplary core model of Source Code Block 1 can be used for a simulation of the hardware platform described with respect to FIGS. 3 and 6. The interaction of the core model of Source Code Block 1 with other models is explained in the following description.

As described above, the core model 605 of FIG. 6, initiates at time point T₀ transaction T61 requesting an instruction fetch operation to instruction cache model 610. Transaction T61 corresponds to the implementation of core model of Source Code Block 1 executing the next_device->read( ) function (cf. Source Code Block 1, line 71). When the core model 605 of FIG. 6 receives a reply indicating a PENDING state, the implementation of the core model of Source Code Block 1 would save the parameters (cf. Source Code Block 1, line 75) and would suspend the core model by suspending the clock (cf. Source Code Block 1, line 64).

When the core model 605 of FIG. 6 receives the callback at time point T₀+3T_{C}, the implementation of core model of Source Code Block 1 would proceed to the next stage and would execute the reactivate_clock( ) function for reactivating the scheduling by the simulation engine (cf. Source Code Block 1, line 129).

The following Source Code Block 2 illustrates an exemplary implementation of a functional model according to the first and second embodiments of the present invention. In particular, the Source Code Block 2 describes an instruction cache model in line with the instruction cache model 310 of the exemplary embodiment of FIG. 3 and the instruction cache model 610 of the exemplary embodiment of FIG. 6.

| | |
|---|---|
| 1 | mem_ret_t icache_read(address, size, buffer, callback) |
| 2 | { |
| 3 | line = identify_target_line(address); |
| 4 | |
| 5 | if (line->valid && (line->tag == get_tag(address)) |
| 6 | { |
| 7 | copy_bytes(address, size, buffer, line); |
| 8 | |
| 9 | return COMPLETED(L * clock_ratio); /* we must imagine |
| 10 | that the same device can be used with different clock ratios (clock |
| 11 | ratio = main clock / device clock), this means that its latency is |
| 12 | always L device cycles, but the returned value is related to the main |
| | clock */ |
| 13 | } |
| 14 | else |
| 15 | { |
| 16 | line->tag = get_tag(address); |
| 17 | |
| 18 | mem_ret_t ret = next_device->read( align_address(address), |
| 19 | LINE_SIZE, line, icache_callback); |
| 20 | |
| 21 | if (ret is ERROR) |
| 22 | return ERROR(get_error_code(ret)); |
| 23 | else if (ret is COMPLETED) |
| 24 | { |
| 25 | copy_bytes(address, size, buffer, line); |
| 26 | |
| 27 | return COMPLETED(get_cycles(ret) + L * clock_ratio); |
| 28 | } |
| 29 | else if (ret is PENDING) |
| 30 | { |
| 31 | save_params(address, size, buffer, callback); |
| 32 | |
| 33 | return PENDING; |
| 34 | } |
| 35 | } |
| 36 | } |
| 37 | |
| 38 | |
| 39 | void icache_callback(mem_ret_t ret) |
| 40 | { |
| 41 | if (ret is ERROR) |
| 42 | caller_callback(ERROR(get_error_code(ret)); |
| 43 | else if (ret is COMPLETED) |
| 44 | { |
| 45 | copy_bytes(address, size, buffer, line); |
| 46 | |
| 47 | caller_callback(COMPLETED(get_cycles(ret) + L * |
| | clock_ratio)); |
| 48 | } |
| 49 | else if (ret is PENDING) |
| 50 | assert(0); |
| 51 | } |

### Source Code Block 2

The instruction cache model of Source Code Block 2 shows the behavior of the instruction cache upon a master model (e.g. a CPU) initiating an instruction cache read operation (named icache_read( )). In the case of an instruction cache read operation to a specific address, the model provides for two alternative behaviors.

Firstly, if the address is contained in a line of the cache and the line is marked as being valid (cf. Source Code Block 2, line 5), the instructions are copied from the cache line to a buffer passed by the initiator (cf. Source Code Block 2, line 7) and the model returns a COMPLETED state indicating a successful completion of the instruction cache read operation (cf. Source Code Block 2, line 9). Since the instruction cache is modeled as a functional model, the model replies to the transaction with a result including time information indicating that the read operation would have taken on a real device L cycles multiplied by some clock ratio so that the returned cycle value is related to the main clock (cf. Source Code Block 2, line 9).

Secondly, if the address is not registered in the buffer or if the line is not valid, the model of the instruction cache redirects the read operation to a next device (cf. Source Code Block 2, line 19). There are two different replies possible, which the above illustrated instruction cache model can cope with.

In the case where the next device to which the instruction read operation is redirected and all other devices which are additionally required for executing the read operation are realized as functional models, the read operation is executed (processed) immediately by the model of the next device and the other devices and the result is immediately available together with the reply to the transaction.

In this case, the instruction cache model of Source Code Block 2 inspects the instantaneous reply to the transaction initiating the read operation stored in the return variable ret (cf. Source Code Block 2, line 23). Depending on the state indicated by the return variable ret, the instruction cache model is programmed to perform ERROR handling (cf. Source Code Block 2, lines 23-24), to copy the requested bytes upon receiving a COMPLETED state (cf. Source Code Block 2, lines 27-29) or to trigger a sleep operation upon receiving a PENDING state (cf. Source Code Block 2, lines 31-36).

The COMPLETED state can only be sent by a functional model replying instantaneously to the transaction initiating a read request. In this case, the reply to the model initiating the transaction requesting the instruction cache read includes the sum of the time information received from the next device and the L cycle multiplied by some clock ratio (e.g. the L cycles being determined by duration of the cache miss).

In this case the next device, to which the instruction read operation is redirected by the instruction cache model, is realized as a cycle-based model, the cycle-based model will reply to the transaction requesting the execution of the instruction read operation with an instantaneous reply indicating a PENDING state. Upon a cycle-based model of the next device completing the execution of the operation, the callback mechanism is used.

For the callback mechanism, the instruction cache model provides the icache_callback( ) function (cf. Source Code Block 2, lines 41-54). Upon the cycle-based model completing the initiated transaction and replying indicating a COMPLETED state, the callback function provides for a similar inspection of the return variable ret. Accordingly, upon receipt of the COMPLETED state, the instruction cache model tries to detect time information received from the next device and depending on a success/failure replies to the transaction initiator of the instruction cache read operation with a sum of the time information received from the next device and the time information indicating the L cycles multiplied by some clock ratio (e.g. the L cycles being determined by duration of the cache miss).

The exemplary instruction cache model of Source Code Block 2 can be used for a simulation of the hardware platform described with respect to FIGS. 3 and 6. The interaction of the instruction cache model of Source Code Block 2 with other models is explained in the following description. The core model 605 of FIG. 6 is described to initiate transaction T61 requesting the instruction fetch operation to instruction cache model 610. Upon receipt of transaction T61 by the instruction cache of Source Code Block 2, the instruction cache of Source Code Block 2 would at first determine if the address supplied with the instruction fetch operation was contained in a line and that line was marked as being valid (cf. Source Code Block 2, line 5).

In the case where this determination results in a cache-miss, the instruction cache model of Source Code Block 2 would initiate a transaction requesting the execution of a read operation by a next device (cf. Source Code Block 2, line 19). This transaction corresponds to the transaction T62 of FIG. 6.

When instruction cache model 610 of FIG. 6 receives a reply indicating a PENDING state within the same clock cycle, the instruction cache model of Source Code Block 2 would save the parameters (cf. Source Code Block 2, line 33) and would return a result indicating a PENDING state to the core model (cf. Source Code Block 2, line 35).

The memory model 615 is described as issuing the callback at time point T₀+3T_{C} in FIG. 6. Accordingly, the instruction cache model of Source Code Block 2 would proceed to inspect the transaction result and would copy the requested bytes (cf. Source Code Block 2, line 47) and use the callback mechanism to return to the core model with a reply indicating the COMPLETED state and returning L cycles multiplied by some clock ratio.

The following Source Code Block 3 illustrates an exemplary implementation of a model with a cycle-based and a functional implementation of the same operation according to the embodiment 3 of the present invention. In particular, the Source Code Block 3 describes a memory model in line with the memory model 315 of the exemplary embodiment of FIG. 3 and the instruction cache model 615 of the exemplary embodiment of FIG. 6.

In accordance with the above description of embodiments of the present invention, the implementation provides for a dynamic cooperation between models. The models interact initiating and replying to transactions. As the different types of models, namely functional and cycle-based models, implement the same interface the two types of models can be interchangeably used in the simulation. In particular, the model type can be changed either by dynamically replacing one model type by a different model type or by dynamically reconfiguring a model including a cycle-based implementation of an operation and a functional implementation of the same operation.

For this purpose, the simulation system may define an internal state determining which of the models or which of the implementations is used for a particular transaction. Instead of an internal state, the simulation system may also read a configuration file upon startup or expect a user instruction via an input (e.g. keyboard, mouse, touch screen). Thereby, a user is enabled to determine the behavior of the simulation. Alternately, the internal state may be changed depending on a simulation condition, e.g. a predefined simulation duration and/or a predefined simulation result. Thereby, the simulation speed or the simulation accuracy can be improved as illustrated through the following pseudo code:

| | |
|---|---|
| 1 | mem_ret_t mem_read(address, size, buffer, callback) |
| 2 | { |
| 3 | if (current_mode_is_functional) |
| 4 | { |
| 5 | if (new_mode_must_be_cycle_based) // this can be |
| 6 | specified by the user for example and can be related to a particular |
| 7 | clock cycle, i.e. start behaving like a cycle-accurate model |
| | after cycle C |
| 8 | { |
| 9 | change_current_mode_to_cycle_based( ); |
| 10 | |
| 11 | // we need the clock for implementing the cycle-based model |
| 12 | enable_clock( ); |
| 13 | |
| 14 | // start new transactions in cycle-accurate mode |
| 15 | return mem_read_cycle_based(address, size, buffer, |
| | callback); |
| 16 | } |
| 17 | else |
| 18 | // start new transactions in functional mode |
| 19 | return mem_read_functional(address, size, buffer, callback); |
| 20 | } |
| 21 | else |
| 22 | { |
| 23 | if (new_mode_must_be_functional) |
| 24 | { |
| 25 | if (no_more_pending_cycle_based_transactions) |
| 26 | { |
| 27 | change_current_mode_to_functional( ); |
| 28 | |
| 29 | // we don't need the clock for implementing the |
| | functional model |
| 30 | disable_clock( ); |
| 31 | } |
| 32 | |
| 33 | // in any case start new transactions in functional mode |
| 34 | return mem_read_functional(address, size, buffer, callback); |
| 35 | } |
| 36 | else |
| 37 | // start new transactions in cycle-based mode |
| 38 | return mem_read_cycle_based(address, size, buffer, |
| | callback); |
| 39 | } |
| 40 | } |
| 41 | |
| 42 | |
| 43 | mem_ret_t mem_read_cycle_based(address, size, buffer, callback) |
| 44 | { |
| 45 | latency = compute_latency(address, size); |
| 46 | |
| 47 | add_pending_trans(address, size, buffer, callback, latency); |
| 48 | |
| 49 | return PENDING; |
| 50 | } |
| 51 | |
| 52 | |
| 53 | mem_ret_t mem_read_functional(address, size, buffer, callback) |
| 54 | { |
| 55 | latency = compute_latency(address, size); |
| 56 | |
| 57 | copy_bytes(address, size, buffer); |
| 58 | |
| 59 | return COMPLETED(latency * clock_ratio); |
| 60 | } |
| 61 | |
| 62 | |
| 63 | void mem_clock_eval( ) |
| 64 | { |
| 65 | for (p = pending_trans; p != NULL; p = p->next) |
| 66 | p->count−−; |
| 67 | } |
| 68 | |
| 69 | |
| 70 | void mem_clock_commit( ) |
| 71 | { |
| 72 | for (p = pending_trans; p != NULL; p = n) |
| 73 | { |
| 74 | n = p->next; |
| 75 | |
| 76 | if (p->count == 0) |
| 77 | { |
| 78 | copy_bytes(address, size, buffer); |
| 79 | |
| 80 | remove_pending_trans(p); |
| 81 | |
| 82 | caller_callback(COMPLETED(0)); |
| 83 | } |
| 84 | } |

### Source Code Block 3

In the memory model of Source Code Block 3, the behavior of the model can be changed according to an internal state of the simulation system, namely state variable new_mode_must_be_cycle_based and new_mode_must_be_functional. In the case where the state variable new_mode_must_be_cycle_based is true (cf. Source Code Block 3, line 5), the behavior of the memory model is switched to become a cycle-based model by enabling the clock (cf. Source Code Block 3, line 14) and triggering the cycle-based implementation of the read operation through the function mem_read_cycle_based( ) (cf. Source Code Block 3, line 17). In the case where the state variable new_mode_must_be_functional is true (cf. Source Code Block 3, line 26), the behavior of the memory model is switched to become a functional model by disabling the clock (cf. Source Code Block 3, line 14) and initiating the functional implementation of the read operation through the function mem_read_functional( ) cf. Source Code Block 3, line 38).

In memory model of Source Code Block 3 a state variable determines if the model behaves like a cycle-based model or like a functional model. The behavior may be set by a user for the whole duration of the simulation. Alternately, a user may also specify the behavior of the memory model to change depending on to a predefined clock cycle of the simulation clock. Defining a clock cycle of the simulation clock to switch a model from a cycle-based behavior to a functional behavior may allow for a faster completion of the simulation after the specified clock cycle (e.g. after clock cycle C). Defining a clock cycle of the simulation clock to switch a model from a functional behavior to a cycle-based behavior may allow for a more accurate simulation after the specified clock cycle (e.g. after clock cycle C where C determines a time point when the simulated hardware platform starts performing a set of instructions which is of interest to a user).

Regarding the cycle-based implementation of the memory model of Source Code Block 3, the functions mem_read_cycle_based( ) mem_clock_eval( ) and mem_clock_commit( ) are important to this cycle-based implementation.

In particular, after the determination of the model behavior (cf. Source Code Block 3, lines 3-45), the cycle-based implementation of the memory model first determines the latency of the read operation for simulating this latency by the number of pending cycles (cf. Source Code Block 3, line 51). Second, the read operation is registered for the memory read operation to be scheduled by the simulation engine (cf. Source Code Block 3, line 53). Thereafter, the memory model replies with a result indicating a PENDING state to the model which has initiated the read operation (cf. Source Code Block 3, line 55).

Further, the memory model of Source Code Block 3 has a mem_clock_eval( ) function and a mem_clock_commit( ) function to be executed by the simulation engine upon the read operation being registered as pending operation. Accordingly, for processing the read operation the simulation engine executes the mem_clock_eval( ) function which only decrements the internal counter simulating the latency of the memory. As there may be more than one transaction requesting a read operation to the simulated memory model, a list of pending transactions is used for storing each transaction requesting a read operation. This list is used to iterate through the pending transactions decrementing the internal counter for each of the pending transactions (cf. Source Code Block 3, lines 69-70).

The mem_clock_commit( ) function of the memory model of Source Code Block 3 implements a reply to the transaction requesting the read operation. For the pending transactions, the memory model determines if the internal counter has become zero which indicates that the latency of the memory has elapsed (cf. Source Code Block 3, lines 74-80). If the counter has become zero, the bytes to be read are copied to the specified address (cf. Source Code Block 3, line 82), the transaction is deregistered (i.e. removed) from the list of pending transactions (cf. Source Code Block 3, line 84) and the callback mechanism is executed to return to the model initiating the transaction requesting the read operation with a result indicating a COMPLETED state. The result to the model initiating the transaction also includes a zero to indicate that the operation has already completed.

Regarding the functional implementation of the memory model of Source Code Block 3, the function mem_read_functional( ) is an important function.

After the determination of the model behavior (cf. Source Code Block 3, lines 3-45), the functional implementation of the memory model of Source Code Block 3 first determines the latency of the read operation to be simulated (cf. Source Code Block 3, line 59), second copies the bytes to be read to the specified address (cf. Source Code Block 3, line 61) and thereafter returns to the initiating model with a result including a COMPLETED state and time information indicating that the read operation would have taken LATENCY device cycles (i.e. a number of cycles corresponding to the determined latency (cf. Source Code Block 3, line 65)).

The exemplary memory model of Source Code Block 3 can be used for a simulation of the hardware platform described with respect to FIGS. 3 and 6. The interaction of the memory model of Source Code Block 3 with other models is explained in the following description.

For the following example, the memory model of Source Code Block 2 is determined to be a cycle-based model. Accordingly, only the functions mem_read_cycle_based( ) mem_clock_eval( ) and mem_clock_commit( ) are used.

When the instruction cache model 610 of FIG. 6 issues at time point T₀+T_{C} transaction T62 requesting the instruction read operation, the memory model of Source Code Block 3 would register a PENDING transaction to be scheduled by the simulation engine by the add_pending_trans( ) function (cf. Source Code Block 3, line 51).

Thereafter, the memory model Source Code Block 3 would immediately reply to the instruction cache model indicating a PENDING state (cf. Source Code Block 3, line 53).

Due to the memory model of Source Code Block 3 registering the transaction requesting the execution of an instruction read operation in the list of pending transactions, the simulation engine—with a latency of three cycles—would schedule the execution of the processing of the transaction for the three consecutive cycles, for each cycle first the mem_clock_eval( ) is called and then the mem_clock_commit( ) function is called. (cf. Source Code Block 3, lines 68-83).

The third execution of the mem_clock_commit( ) function of the memory model of Source Code Block 3 would result in the completion of the instruction read operation. The memory model of Source Code Block 3 would copy the requested instruction to some address of the instruction cache (cf. of Source Code Block 3, line 82). Additionally, the memory model of Source Code Block 3 would deregister the transaction from the list of pending transactions (cf. Source Code Block 3, line 84) and would employ the callback mechanism to reply to the instruction cache indicating a COMPLETED state with zero cycles (cf. Source Code Block 3, line 86).

One skilled in the art will understand that even though various embodiments and advantages of the present invention have been set forth in the foregoing description, the above disclosure is illustrative only, and changes may be made in detail, and yet remain within the broad principles of the disclosed invention. Therefore, the invention disclosed in the present application is to be limited only by the appended claims.

1. A computer-implemented method for simulating a multi-core hardware platform including a plurality of devices, each device being represented in the simulation by either a functional model or a cycle-based model, and the method being run on a simulation system and the method comprising the operations of:
initiating a transaction by a model taking the role of a master model to request the execution of an operation by a model taking the role of a slave model,
executing the requested operation by the slave model, and
replying to the transaction by the slave model by returning a result of the executed operation to the master model;
wherein when the slave model is a functional model, the slave model in the simulation being adapted to execute the operation requested by the transaction and immediately reply thereto by returning the result of the executed operation and information on the execution time of the operation, and
wherein the execution time indicates an estimated number of cycles of a main clock which the device represented by the functional slave model would require for executing the operation.

2. The computer-implemented method according to claim 1, wherein when the slave model is a cycle-based model, a simulation engine of the computer implemented method schedules the execution of the operation requested by the transaction and the reply thereto relative to the cycles of a main clock.

3. The computer-implemented method according to claim 2, wherein each cycle-based model has a predefined cycle TC which is an integer multiple of a cycle TM of the main clock, and
the simulation engine is adapted to schedule the execution of an operation requested by a transaction and a reply thereto of each of the cycle-based models relative to the respective cycle TC.

4. The computer-implemented method according to claim 1,
wherein the master model is a cycle-based master model, and
wherein upon receipt of the reply to the transaction including the result and the information on the execution time, the master model is suspended for a number of cycles of the main clock corresponding to the execution time indicated in the received information.

5. The computer-implemented method according to claim 1,
wherein the master model is a functional model and the master model takes the role of a slave model for another master model representing a device of the simulated hardware platform, the other master model initiating another transaction for requesting the execution of an operation by the master model, and
wherein upon receipt of the reply to the transaction including the result and the information on the execution time, the master model executes the operation requested by the other transaction and immediately replies thereto by returning the result of the execution of the different operation and the sum of the received number of cycles and of the estimated number of cycles associated with the execution of the operation as information on the execution time.

6. The computer-implemented method according to claim 2, wherein the simulation engine is adapted to schedule the execution of an operation requested by a transaction and a reply thereto of each of the cycle-based models at different points in time within a cycle of the main clock.

7. The computer-implemented method according to claim 1, wherein the result which is returned by a slave model as a reply to a transaction requesting the execution of an operation indicates one of the following states:
COMPLETED state, where the operation is successfully completed;
PENDING state, where the operation is pending; and
ERROR state, where the execution of the operation results in an error.

8. The computer-implemented method according to claim 7, wherein the simulation engine is adapted to suspend a master model upon the master model receiving as a reply to a transaction requesting the execution of an operation of a slave model a result indicating a PENDING state.

9. A computer-implemented method for simulating a multi-core hardware platform comprising a plurality of devices, each device being represented in the simulation by either a functional model and/or a cycle-based model, wherein at least one device of the hardware platform is represented by both a functional model and a cycle-based model, the functional model and the cycle-based model having a common interface, and the method being run by a simulation system that executes the operations of:
initiating a transaction by a model taking the role of a master model to request the execution of an operation by one of the functional model and the cycle-based model representing the same device of the hardware platform,
determining according to an internal state of the simulation system which one of the two models is used as slave model for the device,
executing the requested operation by the determined slave model, and
replying to the transaction by the slave model returning a result of the executed operation to the master model.

10. The computer-implemented method according to claim 9, wherein when the slave model is a functional model, the slave model in the simulation is adapted to execute the operation requested by the transaction and immediately reply thereto by returning the result of the executed operation and information on the execution time, and
wherein the execution time indicates an estimated number of cycles of a main clock which the device represented by the functional slave model would have required for executing the operation.

11. The computer-implemented method according to claim 10, wherein when the slave model is a cycle-based model, a simulation engine of the computer implemented method schedules the execution of the operation requested by the transaction and the reply thereto relative to the cycles of a main clock.

12. A computer-implemented method for simulating a multi-core hardware platform comprising a plurality of devices, each device being represented in the simulation by either a functional model and/or a cycle-based model, wherein at least one device of the hardware platform is represented by a model including a cycle-based implementation of an operation and a functional implementation of the same operation, the method being run by a simulation system and the method comprising the operations of:
initiating a transaction by a model taking the role of a master model to request the execution of an operation by a model taking the role of a slave model, the slave model including a cycle-based implementation of the requested operation and a functional implementation of the same operation,
determining according to an internal state of the simulation system which one of the two implementations is to be used by the slave model for executing the requested operation,
executing the requested operation by the slave model using the determined implementation of the slave model, and
replying to the transaction by the slave model returning a result of the executed operation to the master model.

13. The computer-implemented method according to claim 12, wherein when the slave model is a functional model, the slave model in the simulation is adapted to execute the operation requested by the transaction and immediately reply thereto by returning the result of the executed operation and information on the execution time, and
wherein the execution time indicates an estimated number of cycles of a main clock which the device represented by the functional slave model would have required for executing the operation.

14. The computer-implemented method according to claim 13 wherein when the slave model is a cycle-based model, a simulation engine of the computer implemented method schedules the execution of the operation requested by the transaction and the reply thereto relative to the cycles of a main clock.

15. The computer-implemented method according to claim 13, wherein each cycle-based model has a predefined cycle TC which is an integer multiple of a cycle TM of the main clock, and
the simulation engine is adapted to schedule the execution of an operation requested by a transaction and a reply thereto of each of the cycle-based models relative to the respective cycle TC.

16. The computer-implemented method according to claim 13,
wherein the master model is a cycle-based master model, and
wherein upon receipt of the reply to the transaction including the result and the information on the execution time, the master model is suspended for a number of cycles of the main clock corresponding to the execution time indicated in the received information.

17. The computer-implemented method according to claim 13,
wherein the master model is a functional model and the master model takes the role of a slave model for another master model representing a device of the simulated hardware platform, the other master model initiating another transaction for requesting the execution of an operation by the master model, and
wherein upon receipt of the reply to the transaction including the result and the information on the execution time, the master model executes the operation requested by the other transaction and immediately replies thereto by returning the result of the execution of the different operation and the sum of the received number of cycles and of the estimated number of cycles associated with the execution of the operation as information on the execution time.

18. The computer-implemented method according to claim 13, wherein the simulation engine is adapted to schedule the execution of an operation requested by a transaction and a reply thereto of each of the cycle-based models at different points in time within a cycle of the main clock.

19. The computer-implemented method according to claim 13, wherein the result which is returned by a slave model as a reply to a transaction requesting the execution of an operation indicates one of the following states:
COMPLETED state, where the operation is successfully completed;
PENDING state, where the operation is pending; and
ERROR state, where the execution of the operation results in an error.

20. The computer-implemented method according to claim 19, wherein, the simulation engine is adapted to suspend a master model upon the master model receiving as a reply to a transaction requesting the execution of an operation of a slave model a result indicating a PENDING state.

21. A computer-readable storage medium holding a computer program for simulating a multi-core hardware platform including a plurality of devices, each device being represented in the simulation by either a functional model or a cycle-based model, and the program operable to perform the operations of:
initiating a transaction by a model taking the role of a master model to request the execution of an operation by a model taking the role of a slave model;
executing the requested operation by the slave model; and
replying to the transaction through the slave model returning a result of the executed operation to the master model; and
wherein when the slave model is a functional model, the slave model in the simulation is adapted to execute the operation requested by the transaction and immediately reply thereto by returning the result of the executed operation and information on the execution time of the operation, the execution time indicating an estimated number of cycles of a main clock which the device represented by the functional slave model would require for executing the operation.

22. A computer system, comprising:
a simulation system operable to simulate a multi-core hardware platform, the multi-core hardware platform including,
a plurality of devices, each device represented in the simulation system through a corresponding functional or cycle-based model, and at least some of the models in the simulation system being operable to:
initiate a transaction through a first model that provides a transaction to a second model, with the first mode that initiates the transaction being a master model and the second model that receives the transaction being a slave model, and the transaction requesting the slave model to execute a corresponding operation and the slave model, upon executing the operation, providing a reply to the transaction to the master model that includes a result of the executed operation, and the slave model being operable, when the slave model is a functional model, to immediately reply to the transaction from the master model by returning the result of the executed operation and information about the execution time of the executed operation, where the execution time indicates an estimated number of cycles of a main clock which the device represented by the functional slave model would require for executing the operation.

23. The computer system of claim 22, wherein the computer system includes a general purpose computer on which the simulation system executes.

24. The computer system of claim 22, wherein the multi-core hardware platform corresponds to one of a multimedia device, a television, a multi-channel HIFI system, a networking device, a mobile phone, a personal digital assistant, an MP3 player, and a general purpose computer.

25. The computer system of claim 22, wherein the multimedia device comprises one of a DVD player, Blu-Ray player, and hard-drive digital video recorder.

26. The computer system of claim 22, wherein at least some of the master models are a DMA controller or a cache memory.

27. The computer system of claim 22, wherein at least some of the slave models correspond to a bus, a main memory, a network-on-chip, or a bridge device.

28. The computer system of claim 22, wherein at least some of the slave models are cycle-based models and wherein for each cycle-based slave model the simulation system schedules the execution of the operation requested by the transaction and the reply thereto by the slave model relative to the cycles of a main clock.

29. The computer system of claim 28, wherein each cycle-based model has a predefined cycle TC which is an integer multiple of a cycle TM of the main clock.

30. The computer system of claim 29, wherein the simulation system is adapted to schedule the execution of an operation requested by a transaction and a reply thereto for each of the cycle-based models relative to the respective cycle TC.

31. The computer system of claim 22,
wherein each master model is a cycle-based master model; and
wherein upon receipt of the reply to the transaction including the result and the information on the execution time, the master model is suspended for a number of cycles of the main clock corresponding to the execution time indicated in the received information.

32. The computer system of claim 22,
wherein each master model is a functional model and the master model takes the role of a slave model for another master model representing a device of a simulated hardware platform corresponding to the simulation system, the other master model initiating another transaction for requesting the execution of an operation by the master model, and
wherein upon receipt of the reply to the transaction including the result and the information on the execution time, the master model executes the operation requested by the other transaction and immediately replies thereto by returning the result of the execution of the different operation and the sum of the received number of cycles and of the estimated number of cycles associated with the execution of the operation as information on the execution time.

33. The computer system of claim 22, wherein the simulation system is operable to schedule the execution of an operation requested by a transaction and a reply thereto for each of the cycle-based models at different points in time within a cycle of the main clock.

34. The computer system of claim 22, wherein the result returned by a slave model includes one of:
a COMPLETED state, where the operation has been successfully completed;
a PENDING state, where the operation is pending; and
an ERROR state, where the execution of the operation results in an error.

35. The computer system of claim 34, wherein the simulation system is operable to suspend a master model upon the master model receiving a reply that includes a result indicating a PENDING state.

36. The computer system of claim 22, wherein at least one device of the multi-core hardware platform is represented through both a functional model and a cycle-based model, the functional model and the cycle-based model having a common interface.

37. The computer system of claim 26, wherein the simulation system determines, from an internal state of the simulation system, which one of the two models is to be used for each device that is represented through both a functional and a cycle-based model.

38-59. (canceled)
